(19) United States
(12) Patent Application Publication
(10) Pub. No.: US 2006/0134541 A1
(43) Pub. Date: Jun. 22, 2006

(54) Electrophotographic photoreceptor

(75) Inventors: Akiteru Fujii, Kanagawa (JP); Yuka Nagao, Kanagawa (JP); Masayuki Hiroi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 11/144,839

(22) Filed: Jun. 6, 2005

Related U.S. Application Data
(63) Continuation of application No. PCT/JP03/15615, filed on Dec. 5, 2003.

(30) Foreign Application Priority Data
Dec. 6, 2002 (JP) P.2002-355605

(51) Int. Cl. G03G 5/06

(52) U.S. Cl. 430/74; 430/96

(57) ABSTRACT

A subject for the invention is to provide an electrophotographic photoreceptor which has high durability in exposure to ozone, NOₓ, etc., is excellent in mechanical properties including printing durability, wearing resistance, scratch resistance, and slip properties in repetitions of use, and further has excellent electrophotographic properties. The invention relates to an electrophotographic photoreceptor comprising an electro conductive substrate and at least a photosensitive layer formed thereover, characterized in that the photosensitive layer contains at least a polyarylate resin and an amine compound represented by a specific structure.

### FIELD OF THE INVENTION

The present invention relates to an electrophotographic photoreceptor comprising an electro conductive substrate and a photosensitive layer formed thereover. More particularly, the invention relates to an electrophotographic photoreceptor excellent in gas resistance and electrical properties and satisfactory in stability and durability.

### BACKGROUND ART

Electrophotography is extensively used and applied in recent years not only in the field of copiers but in the field of various printers because of its instantaneous, ability to-give high-quality images, etc.

With respect to the photoreceptor which is the nucleus of electrophotography, inorganic photoconductors such as selenium, arsenic-selenium alloys, cadmium sulfide, and zinc oxide have hitherto been used as photoconductive materials therefor. Recently, photoreceptors employing an organic photoconductive material having advantages such as non-polluting properties, ease of film formation, and ease of production have been developed.

Known organic photoreceptors include the so-called dispersion type photoreceptor comprising a binder resin and fine photoconductive particles dispersed therein and the multilayer photoreceptor having a multilayer structure comprising a charge-generating layer and a charge-transporting layer. The multilayer photoreceptor has come to be mainly used because a photoreceptor having high sensitivity is obtained by using a charge-generating substance and a charge-transporting substance both having high efficiency in combination, because there is a wide choice of materials and a highly safe photo receptor is obtained, and because the coating operations contribute to high productivity and are relatively advantageous in cost. Photoreceptors of this type have been intensively developed and put to practical use. Since the electrophotographic photoreceptor is repeatedly used in electrophotographic processes, i.e., cycles each comprising charging, exposure, development, transfer, cleaning, erase, etc., it receives various stresses during the processes and deteriorate. Examples of chemical deteriorations, among such deteriorations, include the damage to the photosensitive layer caused by the ozone, which is highly oxidative, and NOₓ generated by the corona charging device usually used as a charging device. There is a problem that repetitions of use cause deteriorations in electrical stability, such as a decrease in charge acceptance and an increase in residual potential, and hence result in image failures. Besides such chemical deteriorations, the photosensitive layer suffers mechanical deteriorations. There frequently are cases where the surface of the photosensitive layer is worn or marred by friction with the cleaning blade, magnetic brush, or the like, contact with a developer and paper, etc., and this is apt to result in image defects. Such chemical and mechanical deteriorations of the photoreceptor constitute important factors which limit the life of the photoreceptor because they directly impair image quality. Namely, for the development of a photoreceptor having a long life, it is essential not only to heighten chemical durability but also to simultaneously heighten mechanical properties (frictional and wearing properties).

Techniques which have been used for inhibiting chemical deteriorations are to heighten the chemical stability of individual materials contained in the photosensitive layer and, besides this, to add an antioxidant or the like. Known examples thereof include hinderedphenol, thioether, phosphorus compound, and hindered amine additives. Of these, hindered phenol antioxidants have been exclusively used for the systems employing a polycarbonate resin as a binder resin because of their high effect, reduced side effects, and inexpensiveness (see, for example, JP-A-7-191476).

On the other hand, mechanical durability considerably depends on the binder resin. As the binder resin are used thermoplastic resins such as vinyl polymers, e.g., poly (methyl methacrylate), polystyrene, and poly(vinyl chloride), copolymers thereof, polycarbonates, polyesters, polysulfones, and phenoxy, epoxy, and silicone resins and various thermosetting resins. Of these binder resins, polycarbonate resins have relatively excellent performances. Various polycarbonate resins have so far been developed and put to practical use.

However, the polycarbonate resins which have hitherto been used in many photoreceptors have frequently come not to sufficiently meet the recent desire for life prolongation. In particular, it has been found that the polycarbonate resins have a high coefficient of friction (poor slippiness) and further have insufficient wearing resistance. It is also known that the electrophotographic properties of a photoreceptor are considerably influenced also by the binder resin. There have been almost no binder resins which are equal or superior in durability to the polycarbonate resins presently in use, are not inferior in electrophotographic properties to these resins, and pose no problem concerning photoreceptor production. There has been an earnest desire for the development of a photoreceptor employing such a binder resin having a well balanced combination of durability and electrophotographic properties.

Under these circumstances, a technique concerning an electrophotographic photoreceptor employing as a binder a polyester resin having the following structure, which is commercially available under the trade name of “U-Polymer”, was disclosed and it is shown therein that this photoreceptor is superior especially in sensitivity to polycarbonate-containing ones (see, for example, JP-A-56-135844).

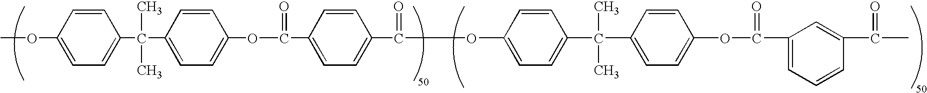

However, “U-Polymer” has poor solubility in solvents. With respect to electrophotographic properties also, this polymer has a low charge mobility, which results in poor responsiveness. This electrophotographic photoreceptor does not withstand use in medium- to high-speed electrophotographic processes.

An electrophotographic photoreceptor characterized by employing a binder resin comprising a polyester copolymer having a structure formed by using tetramethylbisphenol F (bis(4-hydroxy-3,5-dimethylphenyl)methane) and bisphenol A (2,2-bis(4-hydroxyphenyl)propane) as a bisphenol ingredient was hence disclosed (see, for example, JP-A-3-006567).

Furthermore, it has been disclosed that use of a polyester resin produced using a bisphenol ingredient having a specific structure as a binder resin attains improvements in solubility and solution stability although it is equal in electrophotographic properties to the “U-Polymer” described above. It is shown that an electrophotographic photoreceptor employing, in particular, a polyester resin having a specific range of dynamic viscosity, among such polyester resins, is excellent in mechanical strength, especially in wearing resistance (see, for example, JP-A-10-288845).

### DISCLOSURE OF THE INVENTION

There are cases where when a binder resin having higher mechanical durability, e.g., a polyester type resin or a specific polycarbonate resin, is used in order to improve mechanical durability, then the electrophotographic photoreceptor shows poorer resistance to ozone, NOₓ, and the like than in the case of using the polycarbonate resins which have been known as resins suitable for use in electrophotographic photoreceptors. There have been cases where even with the hindered amine antioxidants, a sufficient effect is not obtained. In particular, in the case where the polyester type resin is used, the degree of deterioration of electrophotographic properties caused by the addition of an antioxidant is higher than in the case of using polycarbonate resins. From the standpoint of electrophotographic properties, it is therefore necessary to reduce rather than increase the amount of the antioxidant. There has hence been a desire for the development of a binder resin and an additive which reconcile mechanical properties with electrophotographic properties and chemical stability.

The present inventors made intensive investigations on combinations of a resin usable as a binder resin for photosensitive layers and additives including antioxidants. As a result, it has been found that when a polyarylate resin and a specific amine compound are used, then excellent mechanical durability is attained and chemical deterioration can be specifically prevented without impairing electrophotographic properties, resulting in greatly improved electrical stability in repetitions of use, which in turn greatly improves the stability of image quality. The invention has been thus achieved.

Namely, an essential point of the invention resides in an electrophotographic photoreceptor comprising an electro conductive substrate and at least a photosensitive layer formed thereover, wherein the photosensitive layer contains at least an amine compound represented by the following formula (1) and a polyacrylate resin.

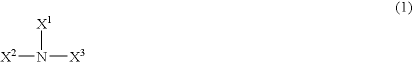

In formula (1), X¹ and X² each independently represents an alkyl group which may have one or more substituents. X³ represents an alkyl group which may have one or more substituents or an aryl group which may have one or more substituents.

### BRIEF DESCRIPTION OF THE DRAWINGS

FIG. 1 is a diagrammatic view illustrating an example of image-forming apparatus employing the electrophotographic photoreceptor of the invention.

In the figure, numeral 1 denotes a photoreceptor, 2 a charging device (charging roller), 3 an exposure device, 4 a developing device, 5 a transfer device, 6 a cleaner, 7 a fixing device, 41 a developing chamber, 42 an agitator, 43 a feed roller, 44 a developing roller, 45 a control member, 71 an upper fixing member (fixing roller), 72 a lower fixing member (fixing roller), and 73 a heater. Furthermore, symbols T and P denote a toner and a recording paper, respectively.

### BEST MODE FOR CARRYING OUT THE INVENTION

The electrophotographic photoreceptor of the invention contains an amine compound incorporated in the photosensitive layer so as to improve the chemical stability of the photoreceptor, i.e., for the purpose of preventing oxidation by the ozone, NOₓ, and the like generated by peripheral devices. Furthermore, the electrophotographic photoreceptor of the invention contains a polyarylate resin as a binder resin for the photosensitive layer.

The amine compound and the polyarylate resin may be contained in any layer as long as this layer is a photosensitive layer. Preferably, however, at least the outermost layer contains them. More preferably, a layer containing a charge-transporting layer contains them. Especially preferably, the charge-transporting layer of a multilayer photoreceptor contains them.

(Amine Compound)

The amine compound in the invention should have moderate basicity and have an oxidation potential or ionization potential higher than the oxidation potential or ionization potential of a charge-transporting material. These properties are important for the stabilization of electrophotographic properties. In case where an amino residue (>NH) is possessed by the compound, this exerts considerable adverse influences on electrophotographic properties. Use of such compound is hence undesirable. Furthermore, compounds having a boiling point of 100° C. or lower are also undesirable because there is a high possibility that such compounds might volatilize in a drying step during photoreceptor production. Although various such amine compounds are known as antioxidants, an amine compound represented by the following formula (1) among these is used in the invention.

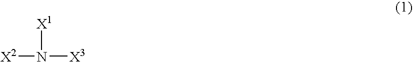

In formula (1) , X¹ and X² each independently represents an alkyl group which may have one or more substituents. X³ represents an alkyl group which may have one or more substituents or an aryl group which may have one or more substituents.

The alkyl groups which may have one or more substituents and can be used as X¹ to X³ are ones in which the alkyl moiety excluding the substituents has generally 1-20 carbon atoms, preferably 1-10 carbon atoms, especially preferably 1-5 carbon atoms. These may have a linear or branched chain structure or a cyclic structure. Preferred of these alkyl groups are linear ones.

More specific examples thereof include alkyl groups in which the alkyl moiety excluding the substituents is methyl, ethyl, propyl, isopropyl, butyl, sec-butyl, t-butyl, pentyl, isopentyl, neopentyl, cyclohexyl, 1-methylheptyl, decyl, dodecyl, hexadecyl, or octadecyl.

The aryl group which may have one or more substituents and can be used as X³ may be a monocyclic one or polycyclic one. In the case of a polycyclic aryl group, it may be a fused polycycle, spiro ring, or ring assembly. However, a fused polycycle is preferred. Especially preferred of these is a monocyclic aryl group.

Preferred examples of the aryl group which may have one or more substituents and can be used as X³ include phenyl, o-tolyl, m-tolyl, p-tolyl, 2,3-xylyl, 2,4-xylyl, 3,4-xylyl, o-cumenyl, m-cumenyl, p-cumenyl, and mesityl.

Examples of the substituents which may be possessed by the alkyl or aryl group in X¹ to X³ include aryl groups such as phenyl, tolyl, cumenyl, naphthyl, and phenanthryl; alkyl groupssuchasmethyl, ethyl, propyl, isopropyl, butyl, isobutyl, and hexyl; alkoxy groups such as methoxy, ethoxy, propyloxy, and butoxy; methoxyphenyl; hydroxyl; cyano; halogen atoms such as fluorine and chlorine atoms; carboxyl; alkoxycarbonyl groups such as ethoxycarbonyl; carbamoyl; aryloxy groups such as phenoxy; arylalkoxy groups such as benzyloxy; and aryloxycarbonyl groups such as phenyloxycarbonyl. Preferred of these are aryl groups, alkyl groups, alkoxy groups, alkoxyphenyl groups, hydroxy, and hydroxyphenyl. Especially preferably used are methyl, phenyl, methoxy, methoxyphenyl, and hydroxyl. Especially preferred of these are ones which are stereostructurally bulky, such as t-butyl, decyl, benzyl, phenethyl, phenyl, and m-tolyl.

More specifically, the amine compound represented by formula (1) preferably is a compound which has an aralkyl group such as benzyl, a-methylbenzyl, or phenethyl as X¹ to X³ because this compound has moderate basicity and oxidation potential and has the excellent function of trapping gases such as ozone and NOₓ. Preferred of such compounds are ones in which two or more of X¹ to X³ each is benzyl or phenethyl. More preferred are ones in which X¹ to X³ each is benzyl or phenethyl.

Preferred examples of the compound represented by formula (1) are shown below.

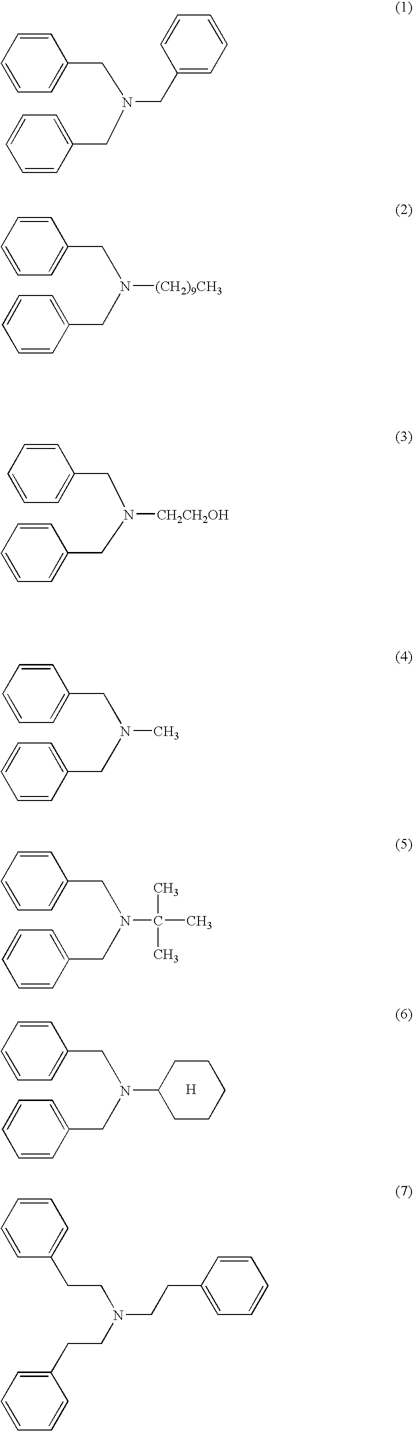

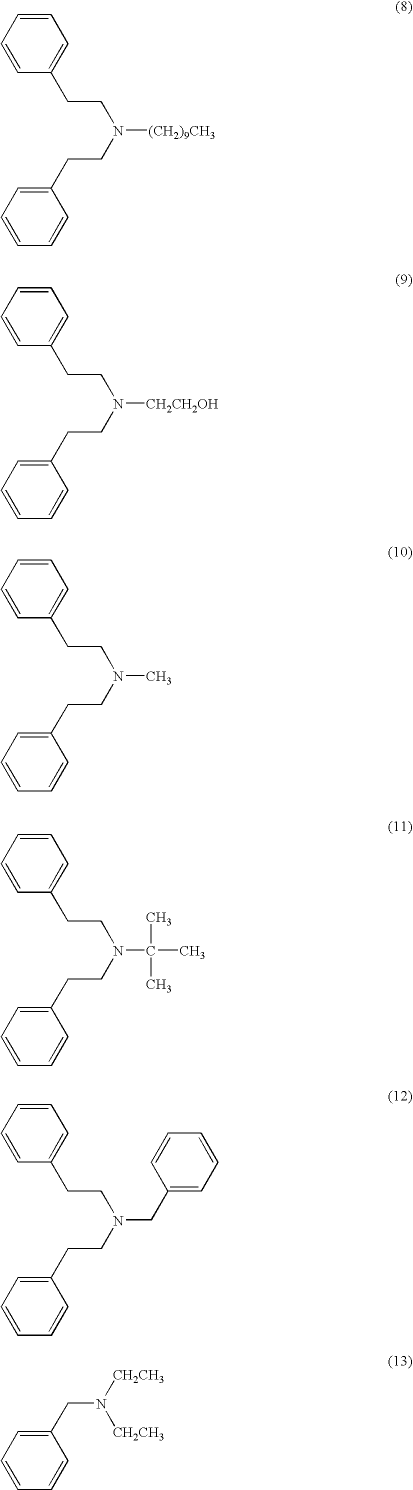

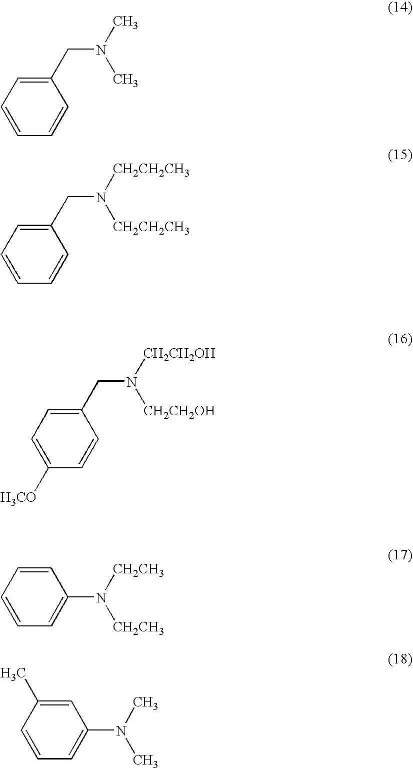

The amine compound according to the invention is incorporated into all or part of the layers (photosensitive layer, protective layer, blocking layer, interlayer, etc.) constituting the photoreceptor for the purpose of imparting chemical stability to the photoreceptor, i.e., preventing oxidation by the ozone, NOₓ, and the like generated by peripheral devices. Chemical deterioration proceeds from the surface layer exposed to the causative substances. It is therefore preferred that at least the outermost layer should contain the amine compound.

Too low contents of the amine compound represented by formula (1) are impractical because a sufficient effect cannot be obtained. Consequently, the amount thereof is generally 0.01 part by weight or larger, preferably 0.05 parts by weight or larger, more preferably 0.1 part by weight or larger, per 100 parts by weight of the whole binder resin which binds the photosensitive layer. Too large amounts thereof exert an adverse influence on the electrophotographic properties of the photoreceptor. The amine compound is hence used in an amount of generally 20 parts by weight or smaller, preferably 10 parts by weight or smaller, more preferably 5 parts by weight or smaller.

(Polyarylate Resin)

The polyarylate resin in the invention binds the photosensitive layer formed over the electro conductive substrate of the electrophotographic photoreceptor and imparts high mechanical stability thereto. This polyarylate resin may be any polyarylate resin usable in electrophotographic photoreceptors. In general, however, it is a resin formed by the bonding of a dihydroxy ingredient to a dicarboxylic acid ingredient through ester linkage. Examples of the dihydroxy ingredient include ones having an aromatic ring in the structure. Examples of the dicarboxylic acid ingredient include ones consisting of: a chain-structure alkylene residue which may have one or more substituents, a cyclic-structure alkylene residue which may have one or more substituents, an alkylidene residue, an arylene residue such as phenylene residue, biphenylene residue, or naphthylene residue, or a diphenyl ether residue; and two carboxy groups bonded thereto.

When the durability of the photosensitive layer, etc. are taken into account, polyarylate resins having a structure represented by the following formula (2) are especially preferred of those polyarylate resins.

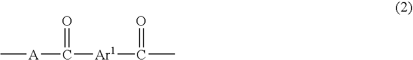

In formula (2), A is divalent groups of one or more kinds represented by the following general formula (3).

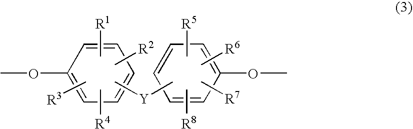

In formula (3), R¹ to R⁸ each independently represents a hydrogen atom or a substituent. Examples of the substituent include alkyl groups which have 1-10 carbon atoms and may have one or more substituents, alkoxy groups which have 1-10 carbon atoms and may have one or more substituents, halogens, halogenoalkyl groups having 1-10 carbon atoms, and aromatic groups which have 6-20 carbon atoms and may have one or more substituents. Preferred of these substituents are alkyl groups which have 1-10 carbon atoms and may have one or more substituents and aromatic groups which have 6-20 carbon atoms and may have one or more substituents.

Y represents a single bond or a divalent group. Examples of the divalent group include chain-structure alkylene groups which have 1-6 carbon atoms and may have one or more substituents, chain-structure alkylidene groups which have 1-6 carbon atoms and may have one or more substituents, cyclic-structure alkylene groups which have 3-6 carbon atoms and may have one or more substituents, cyclic-structure alkylidene groups which have 3-6 carbon atoms and may have one or more substituents, —O—, —S—, —CO—, and —SO₂-. The substituents which may be possessed by the chain-structure alkylene groups having 1-6 carbon atoms preferably are aryl groups, especially preferably phenyl.

The structural part represented by A in formula (2) is one formed from a biphenol ingredient or bisphenol ingredient by removing the hydrogen atoms from the phenolic hydroxy groups. Examples of the structure of the corresponding biphenol ingredient or bisphenol ingredient include the following.

Examples of the biphenol ingredient include 4,4′-biphenol, 2,4′-biphenol, 3,3′-dimethyl-4,4′-dihydroxy-1,1′-biphenyl, 3,3′-dimethyl-2,4′-dihydroxy-1,1′-biphenyl, 3,3′-di(t-butyl)-4,4′-dihydroxy-1,1′-biphenyl, 3,3′,5,5′-tetramethyl-4,4′-dihydroxy-1,1′-biphenyl, 3,3′,5,5′-tetra(t-butyl)-4,4′-dihydroxy-1,1′-biphenyl, and 2,2′,3,3′,5,5′-hexamethyl-4,4′-dihydroxy-1,1′-biphenyl.

Examples of the bisphenol ingredient include
bis(4-hydroxy-3,5-dimethylphenyl)methane,
bis(4-hydroxyphenyl)methane,
bis(4-hydroxy-3-methylphenyl)methane,
1,1-bis(4-hydroxyphenyl)ethane,
1,1-bis(4-hydroxyphenyl)propane,
2,2-bis(4-hydroxyphenyl)propane,
2,2-bis(4-hydroxy-3-methylphenyl)propane,
2,2-bis(4-hydroxyphenyl)butane,
2,2-bis(4-hydroxyphenyl)pentane,
2,2-bis(4-hydroxyphenyl)-3-methylbutane,
2,2-bis(4-hydroxyphenyl)hexane,
2,2-bis(4-hydroxyphenyl)-4-methylpentane,
1,1-bis(4-hydroxyphenyl)cyclopentane,
1,1-bis(4-hydroxyphenyl)cyclohexane,
bis(3-phenyl-4-hydroxyphenyl)methane,
1,1-bis(3-phenyl-4-hydroxyphenyl)ethane,
1,1-bis(3-phenyl-4-hydroxyphenyl)propane,
2,2-bis(3-phenyl-4-hydroxyphenyl)propane,
1,1-bis(4-hydroxy-3-methylphenyl) ethane,
2,2-bis(4-hydroxy-3-ethylphenyl)propane,
2,2-bis(4-hydroxy-3-isopropylphenyl)propane,
2,2-bis(4-hydroxy-3-sec-butylphenyl)propane,
1,1-bis(4-hydroxy-3,5-dimethylphenyl)ethane,
2,2-bis(4-hydroxy-3,5-dimethylphenyl)propane,
1,1-bis(4-hydroxy-3,6-dimethylphenyl)ethane,
bis(4-hydroxy-2,3,5-trimethylphenyl)methane,
1,1-bis(4-hydroxy-2,3,5-trimethylphenyl)ethane,
2,2-bis(4-hydroxy-2,3,5-trimethylphenyl)propane,
bis(4-hydroxy-2,3,5-trimethylphenyl)phenylmethane,
1,1-bis(4-hydroxy-2,3,5-trimethylphenyl)phenylethane,
1,1-bis(4-hydroxy-2,3,5-trimethylphenyl)cyclohexane,
bis(4-hydroxyphenyl)phenylmethane,
1,1-bis(4-hydroxyphenyl)-1-phenylethane,
1,1-bis(4-hydroxyphenyl)-1-phenylpropane,
bis(4-hydroxyphenyl)diphenylmethane,
bis(4-hydroxyphenyl)dibenzylmethane,
4,4′-[1,4-phenylenebis(1-methylethylidene)]bis[phenol],
4,4′-[1,4-phenylenebismethylene]bis[phenol],
4,4′-[1,4-phenylenebis(1-methylethylidene)]bis[2,6-dimethyl phenol],
4,4′-[1,4-phenylenebismethylene]bis[2,6-dimethylphenol],
4,4′-[1,4-phenylenebismethylene]bis[2,3,6-trimethylphenol],
4,4′-[1,4-phenylenebis(l-methylethylidene)]bis[2,3,6-trimet hylphenol],
4,4′-[1,3-phenylenebis(1-methylethylidene)]bis[2,3,6-trimet hylphenol], 4,41-dihydroxydiphenyl ether,
4,4′-dihydroxydiphenyl sulfone, 4,4′-dihydroxydiphenyl sulfide, 3,3′, 5,5′-tetramethyl-4,4′-dihydroxydiphenyl ether,
3,3′,5,5′-tetramethyl-4,4′-dihydroxydiphenyl sulfone,
3,3′,5,5′-tetramethyl-4,4′-dihydroxydiphenyl sulfide, phenolphthalein,
4,4′-[1,4-phenylenebis(1-methylvinylidene)]bisphenol,
4,4′-[1,4-phenylenebis(1-methylvinylidene)]bis[2-methylphen ol], (2-hydroxyphenyl)(4-hydroxyphenyl)methane,
(2-hydroxy-5-methylphenyl)(4-hydroxy-3-methylphenyl)methane,
1,1-(2-hydroxyphenyl)(4-hydroxyphenyl)ethane,
2,2-(2-hydroxyphenyl)(4-hydroxyphenyl)propane, and
1,1-(2-hydroxyphenyl)(4-hydroxyphenyl)propane.

Preferred compounds of these include
bis(4-hydroxy-3,5-dimethylphenyl)methane,
bis(4-hydroxyphenyl)methane,
bis(4-hydroxy-3-methylphenyl)methane,
2,2-bis(4-hydroxy-3-methylphenyl)propane,
1,1-bis(4-hydroxyphenyl)ethane,
2,2-bis(4-hydroxyphenyl)propane,
2-hydroxyphenyl(4-hydroxyphenyl)methane, and
2,2-(2-hydroxyphenyl)(4-hydroxyphenyl)propane.

Especially preferred of these are
bis(4-hydroxy-3,5-dimethylphenyl)methane,
bis(4-hydroxyphenyl)methane, and
(2-hydroxyphenyl)(4-hydroxyphenyl)methane.

Ar¹ in formula (2) represents an aromatic-ring-containing group which may have one or more substituents. These aromatic-ring-containing groups may be of one kind or two or more kinds. Examples of Ar¹ include o-phenylene, m-phenylene, p-phenylene, 4,41-biphenylene, 1,4-naphthylene, 1,2-naphthylene, and a 4,4′-diphenyl ether group. Preferred of these are m-phenylene, p-phenylene, 4,4′-biphenylene, and a 4,4′-diphenyl ether group. Especially preferred are m-phenylene and p-phenylene. Two or more-of these may be used in combination in order to improve solubility.

(Process for Producing Polyarylene Resin)

A known polymerization method can be used as a process for producing the polyarylate resin to be used in the photosensitive layer in the invention. Examples thereof include interfacial polymerization, melt polymerization, and solution polymerization.

In the case of production by, for example, interfacial polymerization, a solution prepared by dissolving a bisphenol ingredient in an aqueous alkali solution is mixed with a solution of an aromatic dicarboxylic acid chloride ingredient in a halogenated hydrocarbon. In this operation, a quaternary ammonium salt or a quaternary phosphonium salt can be caused to be present as a catalyst. From the stand point of productivity, the polymerization temperature and polymerization time are preferably in the ranges of 0-40° C. and 2-12 hours, respectively. After completion of the polymerization, the aqueous phase and the organic phase are separated from each other and the polymer dissolved in the organic phase is cleaned and recovered by a known method. Thus, the target resin is obtained.

Examples of the alkali ingredient to be used here include the hydroxides of alkali metals, such as sodium hydroxide and potassium hydroxide. The amount of the alkali to be used is preferably in the range of 1.01-3 equivalents to the phenolic hydroxyl groups contained in the reaction system.

Examples of the halogenated hydrocarbon to be used here include dichloromethane, chloroform, 1,2-dichloroethane, trichloroethane, tetrachloroethane, and dichlorobenzene.

Examples of the quaternary ammonium salt or quaternary phosphonium salt to be used as a catalyst include salts of tertiary alkyl amines, such as tributylamine and trioctylamine, with hydrochloric acid, bromic acid, iodic acid, or the like, benzyltriethylammonium chloride, benzyltrimethylammonium chloride, benzyltributylammonium chloride, tetraethylammonium chloride, tetrabutylammonium chloride, tetrabutylammonium bromide, trioctylmethylammonium chloride, tetrabutylphosphonium bromide, triethyloctadecylphosphonium bromide, N-laurylpyridinium chloride, and laurylpicolinium chloride.

A molecular-weight regulator may be caused to be present inthepolymerization. Examples thereof includemonofunctional phenols suchasphenol, alkylphenols, e.g., o-, m-, orp-cresol, o-, m-, or p-ethylphenol, o-, m-, or p-propylphenol, o-, m-, orp-tert-butylphenol, pentylphenol, hexylphenol, octylphenol, nonylphenol, and 2,6-dimethylphenol derivatives, and o-, m-, and p-phenylphenols; and monofunctional acid halides such as acetyl chloride, butyryl chloride, octyloyl chloride, benzoyl chloride, benzenesulfonyl chloride, benzenesulfinyl chloride, sulfinyl chloride, benzenephosphonyl chloride, and substitution derivatives of these.

In the polyarylate resin comprising repeating units of a structure represented by formula (2), any group present at an end of the molecular chain, e.g., one derived from the molecular-weight regulator described above, is not included in the repeating units.

The polyarylate resin comprising a structure represented by formula (2) in the invention has a viscosity-average molecular weight of generally 8,000 or higher, preferably 15,000 or higher, more preferably 20,000 or higher. This is because when the viscosity-average molecular weight of the resin is lower than 8,000, the resin has reduced mechanical strength and is impractical. In case where the viscosity-average molecular weight of the resin exceeds 300,000, it is difficult to apply a coating fluid in an appropriate thickness in forming the photosensitive layer on an electro conductive substrate. Consequently, the viscosity-average molecular weight thereof is generally 300,000 or lower, preferably 100,000 or lower, more preferably 60,000 or lower.

The binder resin to be contained in the photosensitive layer of the electrophotographic photoreceptor of the invention may consist only of the polyarylate resin according to the invention or may be a mixture thereof with one or more other resins. Examples of such resins which may be optionally mixed include thermoplastic resins such as vinyl polymers, e.g., poly(methyl methacrylate), polystyrene, and poly(vinyl chloride), copolymers thereof, polycarbonates, polyesters, polysulfones, andphenoxy, epoxy, and silicone resins and various thermosetting resins. Preferred of these resins are polycarbonate resins.

In the case where the polyarylate resin according to the invention is used as a mixture thereof with one or more other resins, the proportions thereof can be selected at will according to the properties required of the electrophotographic apparatus to which the photoreceptor of the invention is to be applied. When mechanical durability and the like are taken into account, the polyarylate according to the invention preferably has the highest proportion among all binder resins. More preferably, the proportion thereof is 50% by weight or higher.

(Electrophotographic Photoreceptor)

As the electro conductive substrate of the electrophotographic photoreceptor is mainly used, for example, a metallic material such as aluminum, an aluminum alloy, stainless steel, copper, or nickel, a resinous material to which electrical conductivity has been imparted by adding a conductive powder such as a metal, carbon, or tin oxide, or a resin, glass, paper, or the like on a surface of which a conductive material such as aluminum, nickel,or ITO (indium-tin oxide) has been deposited by vapor deposition or coating fluid application. The shape of the substrate to be used is a drum form, sheet form, belt form, or the like. The substrate may be one which comprises an electro conductive substrate made of a metallic material and coated with a conductive material having an appropriate value of resistance so as to regulate electrical conductivity/surface properties or the like or to cover defects.

In the case where a metallic material such as, e.g., an aluminum alloy is employed as an electro conductive substrate, it may be used after having been subjected to an anodizing treatment, chemical conversion coating treatment, etc. It is desirable that when an anodizing treatment is performed, the base be then subjected to a sealing treatment by a known method.

The surface of the substrate may be smooth or may have been roughened by a special machining method or by conducting an abrading treatment. Alternatively, the substrate may be one which has been made to have a rough surface by incorporating particles having an appropriate particle diameter into the material constituting the substrate. Furthermore, there are cases where a solid-drawn tube is used as it is without being subjected to a machining treatment, for the purpose of cost reduction.

An undercoat layer may be disposed between the electro conductive substrate and the photosensitive layer for the purpose of improving adhesiveness/blocking properties, etc. As the undercoat layer is generally used a layer comprising a resin or comprising a resin and particles of, e.g., a metal oxide dispersed therein. The undercoat layer may further contain various pigments or dyes.

Examples of the metal oxide particles for use in the undercoat layer include particles of a metal oxide containing one metallic element, such as titanium oxide, aluminum oxide, silicon oxide, zirconium oxide, zinc oxide, or iron oxide, and particles of a metal oxide containing two or more metallic elements, such as calcium titanate, strontium titanate, or barium titanate. Particles of one kind only may be used, or a mixture of particles of two or more kinds maybe used. Preferred of these particulate metal oxides are titanium oxide and aluminum oxide. Titanium oxide is especially preferred. The titanium oxide particles may be ones whose surface has undergone a treatment with an inorganic substance such as tin oxide, aluminum oxide, antimony oxide, zirconium oxide, or silicon oxide or with an organic substance such as stearic acid, a polyol, or a silicone. The crystal form of the titanium oxide particles may be any of rutile, anatase, brookite, and amorphous. The titanium oxide may comprise ones having two or more crystal states.

With respect to the particle diameter of the metal oxide particles, metal oxides having various particle diameters can be utilized. From the standpoints of properties and liquid stability, however, the average primary-particle diameter thereof preferably is 10 nm or larger and 100 nm or smaller, and especially preferably is 10 nm or larger and 50 nm or smaller.

It is desirable that the undercoat layer be formed in the form of a dispersion of metal oxide particles in a binder resin. Examples of the binder resin to be used in the undercoat layer include phenoxies, epoxies, polyvinylpyrrolidone, poly(vinyl alcohol), casein, poly(acrylic acid), cellulose and derivatives thereof, gelatin, starch, polyurethanes, polyimides, and polyamides, and these resins may be cured alone or in combination with a hardener. Of these, alcohol-soluble copolyamides, modified polyamides, and the like are preferred because they are satisfactory in dispersibility and applicability.

The proportion of the inorganic particles to the binder resin can be selected at will. However, from the standpoint of the stability and applicability of the dispersion, it is preferred to use the particles in an amount in the range of from 10 wt % to 500 wt %.

The thickness of the undercoat layer can be selected at will. However, it is preferably from 0.1 μm to 20 μm from the standpoints of photoreceptor properties and applicability. Known-antioxidants and the like may be added to the undercoat layer.

The photosensitive layer formed over the electro conductive substrate may be either the dispersion type or the multilayer type.

(Charge-Generating Substance)

As a charge-generating substance for the photosensitive layer can be used, for example, various photoconductive materials including selenium and alloys thereof, cadmium sulfide, other inorganic photoconductive materials, and organic pigments such asphthalocyanine pigments, azopigments, quinacridone pigments, indigo pigments, perylene pigments, polyaromatic quinone pigments, anthanthrone pigments, and benzimidazole pigments. Organic pigments are especially preferred. More preferred are phthalocyanine pigments and azo pigments.

In the case where a phthalocyanine compound is used as a charge-generating substance, examples thereof include metal-free phthalocyanine and phthalocyanine compounds to which a metal, e.g., copper, indium, gallium, tin, titanium, zinc, vanadium, silicon, orgermanium, oranoxide, halide, hydroxide, alkoxides, or another form of the metal has coordinated.

Preferred are X-form and τ-form metal-free phthalocyanines, which have especially high sensitivity, A-form (also called β-form), B-form (also called α-form), D-form (also called-Y-form), and other titanyl phthalocyanines, vanadyl phthalocyanine, chloroindium phthalocyanine, chlorogallium phthalocyanine, hydroxygallium phthalocyanine, and the like. Of the crystal forms of titanyl phthalocyanine shown above, the A-form and the B-form are shown as the I-phase and II-phase, respectively, by W. Helleretal. (Zeit. Kristallogr., 159(1982) 173), the A-form being known as a stable form. The D-form is a crystal form characterized by showing a distinct peak at a diffraction angle 2θ+0.2° of 27.3° in X-ray powder diffraction using CuKₐ characteristic X-ray. There are cases where this crystal form further has relatively distinct peaks at 9.5°, 15.0°, and 24.1°. A single phthalocyanine compound may be used, or some phthalocyanine compounds in the form of a mixture thereof or in a mixed-crystal state may be used. With respect to the mixed state of the phthalocyanine compounds or in the crystal state, the constituent elements may be mixed later and used. Alternatively, the compounds may be ones which were made to come into the mixed state in phthalocyanine compound production/treatment steps including synthesis, pigment preparation, and crystallization. Known such treatments include an acid paste treatment, grinding treatment, solvent treatment, and the like. Examples of methods for producing a mixed-crystal state include a method which comprises mixing two kinds of crystals together, subsequently mechanically grinding the mixture to make it amorphous, and then treating the mixture with a solvent to thereby convert into a specific crystal state.

(Charge-Generating Layer)

In the case of the charge-generating layer of a multilayered photosensitive layer, the charge-generating substance therefor is used in the state of being bound with various binder resins such as, e.g., polyesters, poly(vinyl acetate), poly(acrylic ester)s, poly(methacrylic ester)s, polycarbonates, poly(vinylacetoacetal), poly(vinylpropional), poly(vinyl butyral), phenoxy resins, epoxy resins, urethane resins, cellulose esters, and cellulose ethers. The proportion of the charge-generating substance to be used is generally in the range of from 30 to 500 parts by weight per 100 parts by weight of the binder resin. The thickness of the layer is generally from 0.1 μm to 1 μm, preferably from 0.15 μm to 0.6 μm.

(Charge-Transporting Substance)

As the charge-transporting substance can be used known ones. Examples thereof include electron-withdrawing substances such as aromatic nitro compounds, e.g., 2,4,7-trinitrofluorenone, cyano compounds, e.g., tetracyanoquinodimetan, and quinones, e.g., diphenoquinone; and electron-donating substances such as heterocyclic compounds, e.g., carbazole derivatives, indole derivatives, imidazole derivatives, oxazole derivatives, pyrazole derivatives, oxadiazole derivatives, pyrazoline derivatives, and thiadiazole derivatives, aniline derivatives, hydrazone compounds, aromatic amine derivatives, stilbene derivatives, butadiene derivatives, enamine compounds, compounds made up of two or more of these compounds bonded to each other, and polymers having a group derived from any of these compounds in the main chain or a side chain.

Preferred of these are carbazole derivatives, hydrazone derivatives, aromatic amine derivatives, stilbene derivatives, butadiene derivatives, and compounds made up of two or more of these derivatives bonded to each other. Preferred are compounds made up of two or more of aromatic amine derivatives, stilbene derivatives, and butadiene derivatives bonded to each other.

These charge-transporting substances may be used alone, or some of these may be used as a mixture thereof.

(Charge-Transporting Layer)

A charge-transporting layer is formed in which the charge-transporting material is in the state of being bound with a binder resin. The charge-transporting layer of a multilayered photosensitive layer may consist of a single layer or may be composed of superposed layers differing in components or in component proportion. The binder resin which binds the charge-transporting layer preferably comprises a polyester resin.

The proportion of the charge-transporting substance to the binder resin, which constitute the charge-transporting layer, is in the range of generally from 30-200 parts by weight, preferably from 40-150 parts by weight, per 100 parts by weight of the binder resin. The thickness of the layer is generally 5-50 μm, preferably 10-45 μm.

Known additives such as plasticizers, antioxidants, ultraviolet absorbers, electron-withdrawing compounds, and leveling agents may be incorporated into the charge-transporting layer for the purpose of improving film-forming properties, flexibility, applicability, nonfouling properties, gas resistance, light resistance, etc.

(Dispersion Type Photosensitive Layer)

In the case of a dispersion type photosensitive layer, the charge-generating substance is dispersed in a charge-transporting medium having a composition such as that shown above.

In this case, the particle diameter of the charge-generating substance should be sufficiently small. The particle diameter of the charge-generating substance to be used is preferably 1 μm or smaller, more preferably 0.5 μm or smaller. In case where the amount of-the charge-gene-rating substance to be dispersed in the photosensitive layer is too small, sufficient sensitivity is not obtained. Too large amounts thereof exert adverse influences, such as reduced charge acceptance and reduced sensitivity. For example, the charge-generating substance is used in an amount preferably in the range of 0.5-50% by weight, more preferably in the range of 1-20% by weight.

The thickness of the photosensitive layer to be used is generally 5-50 μm, more preferably 10-45 μm. In this case also, the layer may contain a known plasticizer for improving film-forming properties, flexibility, mechanical strength, etc., an additive for diminishing residual potential, a dispersion aid for improving dispersion stability, and a leveling agent, surfactant, e.g., a silicone oil or fluorochemical oil, or another additive for improving applicability.

(Other Functional Layers)

A protective layer may be formed on the photosensitive layer for the purposes of preventing the photosensitive layer from being damaged or worn and preventing/diminishing the deterioration of the photosensitive layer caused by, e.g., discharge products generated by a charging device, etc.

The surface layer may contain a fluororesin, silicone resin, or the like so as to reduce the frictional resistance or friction of the photo receptor surface. The layer may contain particles of these resins or particles of an inorganic compound.

(Method of Layer Formation)

Those layers for constituting the photoreceptor are formed through application to a substrate by dip coating, spray coating, nozzle coating, barcoating, roll coating, blade coating, or the like.

For forming the layers, use can be made of a known method such as one in which coating fluids obtained by dissolving or dispersing in a solvent the substances to be incorporated in the respective layers are successively applied.

Examples of the solvent or dispersion medium to be used in coating fluid preparation include alcohols such as methanol, ethanol, propanol, and 2-methoxyethanol, ethers such as tetrahydrofuran, 1,4-dioxane, and dimethoxyethane, esters such as methyl formate and ethyl acetate, ketones such as acetone, methyl ethyl ketone, and cyclohexanone, aromatic hydrocarbons such as benzene, toluene, and xylene, chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene, nitrogen-containing compounds such as n-butylamine, isopropanolamine, diethylamine, triethanolamine, ethylenediamine, and triethylenediamine, and aprotic polar solvents-such as acetonitrile, N-methylpyrrolidone, N,N-dimethylformamide, and dimethyl sulfoxide. These may be used alone or in combination of two or more thereof.

In the case of a single-layer photosensitive layer and in the case of the charge-transporting layer of a multilayered photosensitive layer, the coating fluid or dispersion is prepared so as to result in a solid concentration of preferably 40% by weight or lower, more preferably 10-35% by weight, and a viscosity of preferably 50-300 cps. In the case of the charge-generating layer of a multilayered photosensitive layer, the coating fluid or dispersion is prepared so as to result in a solid concentration of preferably 15% by weight or lower, more preferably 1-10% by weight, and a viscosity of preferably 0.1-10 cps.

After application, the coating film is dried. The drying temperature and period are regulated so that necessary and sufficient drying is conducted. The drying temperature is in the range of generally 100-250° C., preferably 110-170° C., more preferably115-140° C. A drying method employing a hot-air dryer, steam dryer, infrared dryer, far-infrared dryer, or the like can be used.

The electrophotographic photoreceptor of the invention thus obtained retains excellent printing durability and slip properties over long. It is suitable for use in the field of electrophotography such as copiers, printers, facsimile telegraphs, and plate making machines.

(Image-Forming Apparatus)

The image-forming apparatus, such as a copier or printer, employing the electrophotographic photoreceptor of the invention involves at least the process steps of charging, exposure, development, transfer, and erase. Each of these process steps may be conducted by any of methods in ordinary use.

As a charging method (charging device) can be used, for example, corotron or scorotron charging, which utilizes corona discharge. Besides these, use may be made of a direct charging technique in which a direct-charging member to which a voltage is applied is brought into contact with the photoreceptor surface to charge it. As the direct charging technique may be used any of contact charging techniques using a conductive roller or a brush, film, or the like. Such charging techniques maybe either ones accompanied by an aerial discharge or ones not accompanied by an aerial discharge. Of these charging methods, the charging technique using corona discharge preferably is scorotron charging from the standpoint of keeping the dark potential constant. In the case of a contact charging device employing a conductive roller or the like, the charging can be conducted with a direct current or with a direct current on which an alternating current has been superimposed.

With respect to an exposure light, use may be made of a halogen lamp, fluorescent lamp, laser (semiconductoror He—Ne), LED, internal exposure of the photoreceptor, or the like may be used. However, it is preferred to use a laser, LED, light shutter array, or the like in a digital electrophotographic technique. With respect to wavelength, a monochromatic light having a slightly short wavelength in the 600-700 nm region and a monochromatic light having a short wavelength in the 380-500 nm region can be used besides the monochromatic light having a wavelength of 780 nm.

For the development step may be used dry development techniques such as cascade development, development with a one-component insulating toner, development with a one-component conductive toner, and two-component magnetic brush development, liquid development techniques, and other techniques. Usable toners include polymerization toners produced through suspension polymerization or emulsion polymerization and aggregation, besides pulverized toners. Especially in the case of polymerization toners, ones having an average particle diameter as small as about 4-8 μm are used. With respect to shape, usable polymerization toners range from nearly spherical ones to non-spherical potato-shaped ones. Polymerization toners are excellent in charging capability and in transferability and are suitable for use in image quality improvement.

In-the transfer step, use is made of an electrostatic transfer technique, pressure transfer technique, and adhesive transfer technique, such as corona transfer, roller transfer, and belt transfer. For the fixing is used heated-roller fixing, flash fixing, oven fixing, pressure fixing, or the like.

For the cleaning is used a brush cleaner, magnetic brush cleaner, electrostatic brush cleaner, magnetic roller cleaner, blade cleaner, or the like.

The erase step is frequently omitted. When the step is conducted, a fluorescent lamp, LED, or the like is used. With respect to intensity therefor, an exposure energy which is at least 3 times the energy of the exposure light is frequently used. Besides the process steps shown above, a pre-exposure step and an auxiliary charging step may be involved.

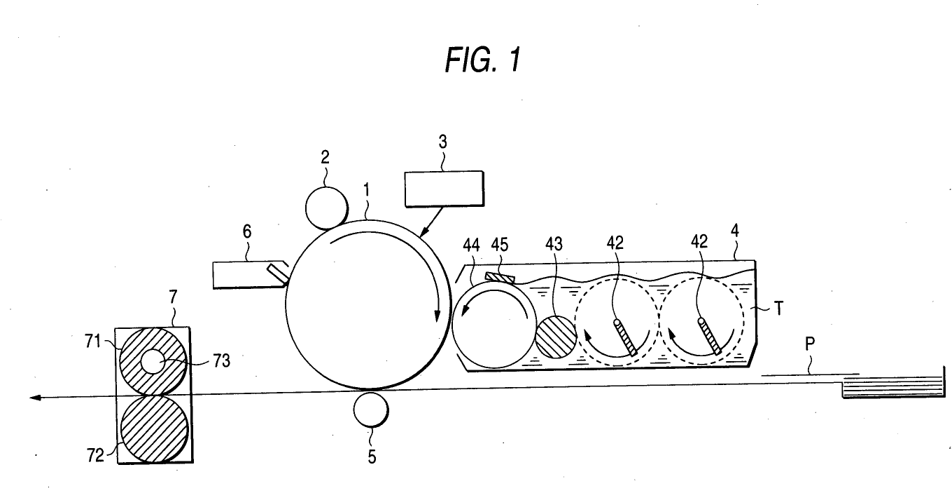

Embodiments of the image-forming apparatus employing the electrophotographic photoreceptor of the invention are explained by reference to FIG. 1, which illustrates the important constitution of the apparatus. However, the embodiments should not be construed as being limited to that explained below, and can be modified at will as long as the modifications do not depart from the spirit of the invention.

As shown in FIG. 1, the image-forming apparatus comprises an electrophotographic photoreceptor 1, a charging device 2, an exposure device 3, and a developing device 4. The apparatus may further has a transfer device 5, a cleaner 6, and a fixing device 7 according to need.

The electrophotographic photoreceptor 1 is not particularly limited as long as it is the electrophotographic photoreceptor of the invention described above. FIG. 1 shows, as an example thereof, a drum-shaped receptor comprising a cylindrical electro conductive substrate and, formed on the surface thereof, the photosensitive layer described above. The charging device 2, exposure device 3, developing device 4, transfer device 5, and cleaner 6 are disposed along the peripheral surface of this electrophotographic photoreceptor 1.

The charging device 2 serves to charge the electrophotographic photoreceptor 1. It evenly charges the surface of the electrophotographic photoreceptor 1 to a given potential. FIG. 1 shows a roller type charging device (charging roller) as an example of the charging device 2. However, corona charging devices such as corotrons and scorotrons, contact type charging devices such as charging brushes, and the like are frequently used besides the charging rollers.

In many cases, the electrophotographic photoreceptor 1 and the charging device 2 are designed to constitute a cartridge (hereinafter sometimes referred to as aphotoreceptor cartridge) which involves these two members and is removable from the main body of the image-forming apparatus. In this constitution, when, for example, the electrophotographic photoreceptor 1 and the charging-device 2 have deteriorated,. this photoreceptor cartridge can be removed from the main body of the image-forming apparatus and a fresh photoreceptor cartridge can be mounted in the main body of the image-forming apparatus. Also with respect to the toner which will be described later, the toner in many cases is designed to be stored in a toner cartridge and be removable from the main body of the image-forming apparatus. In this constitution, when the toner in the toner cartridge in use has run out, this toner cartridge can be removed from the main body of the image-forming apparatus and a fresh toner cartridge can be mounted. There a real so cases where a cartridge containing all of a photoreceptor 1, a charging device 2, and a toner is used.

The exposure device 3 is not particularly limited in kind as long as it can illuminate the electrophotographic photoreceptor 1 and thereby form an electrostatic latent image in the photosensitive surface of the electrophotographic photoreceptor 1. Examples thereof include halogen lamps, fluorescent lamps, lasers such as semiconductor lasers and He—Ne lasers, and LEDs. It is also possible to conduct exposure by the technique of internal photoreceptor exposure. Any desired light can be used for exposure. For example, the monochromatic light having a wavelength of 780 nm, a monochromatic light having a slightly short wavelength of from 600 nm to 700 nm, amonochromatic light having a short wavelength of from 380 nm to 500 nm, or the like may be used to conduct exposure.

The developing device 4 is not particularly limited in kind, and any desired device can be used, such as one operated by a dry development technique, e.g., cascade development, development with one-component conductive toner, or two-component magnetic brush development, a liquid development technique, etc. In FIG. 1, the developing device 4 comprises a developing chamber 41, agitators 42, a feed roller 43, a developing roller 44, and a control member 45. This device has such a constitution that a toner T is stored in the developing chamber 41. According to need, the developing device 4 may be equipped with a replenishing device (not shown) for replenishing the toner T. This replenishing device has such a constitution that the toner T can be supplied from a container such as a bottle or cartridge.

The feed roller 43 is made of an electrically conductive sponge, etc. The developing roller 44 comprises a metallic roll made of iron, stainless steel, aluminum, nickel, or the like, a resinous roll obtained by coating such a metallic roll with a silicone resin, urethane resin, fluororesin, or the like, or the like. The surface of this developing roller 44 may be subjected to a surface-smoothing processing or surface-roughening processing according to need.

The developing roller 44 is disposed between the electrophotographic photoreceptor 1 and the feed roller 43 and is in contact with each of the electrophotographic photoreceptor 1 and the feed roller 43. The feed roller 43 and the developing roller 44 are rotated by a rotation driving mechanism (not shown). The feed roller 43 holds the toner T stored and supplies it to the developing roller 44. The developing roller 44 holds the toner T supplied by the feed roller 43 and brings it into contact with the surface of the electrophotographic photoreceptor 1.

The control member 45 comprises a resinous blade made of a silicone resin, urethane resin, or the like, a metallic blade made of stainless steel, aluminum, copper, brass, phosphor bronze, or the like, a blade obtained by coating such a metallic blade with a resin, etc. This control member 45 is in contact with the developing roller 44 and is pushed against the developing roller 44 with a spring or the like at a given force (the linear blade pressure is generally 5-500 g/cm) . According to need, this control member 45 may have the function of charging the toner T based on electrification by friction with the toner T.

The agitators 42 each are rotated by the rotation driving mechanism. They agitate the toner T and convey the toner T to the feed roller 43 side. Two or more agitators 42 differing in blade shape, size, etc. may be disposed.

The toner T may be of any desired kind. Besides powdery toners, polymerization toners produced by using the suspension polymerization method, emulsion polymerization method, or the like can be used. In particular, when a polymerization toner is used, it preferably is one having a particle diameter as small as about 4-8 μm. Furthermore, polymerization toners in which the toner particles range widely in shape from nearly spherical ones to non-spherical potato-shaped ones can be used. Polymerization toners are excellent in charging capability and in transferability and are suitable for use in image quality improvement.

The transfer device 5 is not particularly limited in kind, and use can be made of a device operated by any desired technique selected from an electrostatic transfer technique, pressure transfer technique, adhesive transfer technique, and the like, such as corona transfer, roller transfer, and belt transfer. Here, the transfer device 5 is one constituted of a transfer charger, transfer roller, transfer belt, or the like disposed so as to face the electrophoto graphic photoreceptor 1. A given voltage (transfer voltage) which has the polarity opposite to that of the charge potential of the toner T is applied to the transfer device 5, and this transfer device 5 thus transfers the toner image formed on the electrophotographic photoreceptor 1 to a recording paper (paper or medium) P.

The cleaner 6 is not particularly limited, and any desired cleaner can be used, such as a brush cleaner, magnetic brush cleaner, electrostatic brush cleaner, magnetic roller cleaner, or blade cleaner. The cleaner 6 serves to scrape off the residual toner adherent to the photoreceptor 1 with a cleaning member and thus recover the residual toner.

The fixing device 7 is constituted of an upper fixing member (fixing roller) 71 and a lower fixing member (fixing roller) 72. The fixing member 71 or 72 is equipped with a heater 73 inside. FIG. 1 shows an example in which the upper fixing member 71 is equipped with a heater 73 inside. As the upper and lower fixing members 71 and 72 can be used a known heat-fixing member such as a fixing roll comprising a metallic tube made of stainless steel, aluminum, or the like and a silicone rubber with which the tube is coated, a fixing roll obtained by further coating the fixing roll with a Teflon resin, or a fixing sheet. Furthermore, the fixing members 71 and 72 each may have a constitution in which a release agent such as a silicone oil is supplied thereto in order to improve release properties, or may have a constitution in which the two members are forcedly pressed against each other with a spring or the like.

The toner which has been transferred to the recording paper P passes through the nip between the upper fixing member 71 heated at a given temperature and the lower fixing member 72, during which the toner is heated to a molten state. After the passing, the toner is cooled and fixed-to the recording paper P.

The fixing device also is not particularly limited in kind. Fixing devices which can be mounted include a fixing device operated by any desired fixing technique, such as heated-roller fixing, flash fixing, oven fixing, or pressure fixing, besides the device used here.

In the electrophotographic apparatus having the constitution described above, image recording is conducted in the following manner. First, the surface (photosensitive surface) of the photoreceptor 1 is charged to a given potential (e.g., −600 V) with the charging device 2. This charging may be conducted with a direct-current voltage or with a direct-current voltage on which an alternating-current voltage has been superimposed.

Subsequently, the charged photosensitive surface of the photoreceptor 1 is exposed with the exposure device 3 according to the image to be recorded. Thus, an electrostatic latent image is formed in the photosensitive surface. This electrostatic latent image formed in the photosensitive surface of the photoreceptor 1 is developed by the developing device 4.

In the developing device 4, the toner T fed by the feed roller 43 is formed into a thin layer with the control member (developing blade) 45 and, simultaneously therewith, frictionally charged so as to have a given polarity (here, the toner is charged so as to have negative polarity, which is the same as the polarity of the charge potential of the photoreceptor 1). This toner T is conveyed while being held by the developing roller 44 and is brought into contact with the surface of the photoreceptor 1.

When the charged toner T held on the developing roller 44 comes into contact with the surface of the photoreceptor 1, a toner image corresponding to the electrostatic latent image is formed on the photosensitive surface of the photoreceptor l. This toner image is transferred to a recording paper P with the transfer device 5. Thereafter, the toner which has not been transferred and remains on the photosensitive surface of the photoreceptor 1 is removed with the cleaner 6.

After the transfer of the toner image to the recording paper P, the recording paper P is passed through the fixing device 7 to thermally fix the toner image to the recording paper P. Thus, a finished image is obtained.

Incidentally, the image-forming apparatus may have a constitution in which an erase step, for example, can be conducted, in addition to the constitution described above. The erase step is a step in which the electrophotographic photoreceptor is exposed to a light to thereby erase the residual charges from the electrophotographic photoreceptor. As an eraser is used a fluorescent lamp, LED, or the like. The light to be used in the erase step, in many cases, is a light having such an intensity that the exposure energy thereof is at least 3 times the energy of the exposure light.

The constitution of the image-forming apparatus may be further modified. For example, the apparatus may have a constitution in which steps such as a pre-exposure step and an auxiliary charging step can be conducted, or have a constitution in which offset printing is conducted. Furthermore, the apparatus may have a full-color tandem constitution employing two or more toners.

### EXAMPLES

The invention will be explained below in more detail by reference to Production Examples, Examples, and Comparative Examples. The invention should not be construed as being limited to the following Examples.

(Production of Binder Resins)

[Measurement of Viscosity-Average Molecular Weight]

A binder resin was dissolved in dichloromethane to prepare a solution having a concentration C of 6.00 g/L. A Ubbelohde capillary viscometer having a flow time for the solvent (dichloromethane) tₒ of 136.16 seconds was used to measure the flow time for the sample solution in a thermostatic water tank set at 20.0° C. The viscosity-average molecular weight Mv was calculated according to the following equations.
a=0.438×ηₛₚ+1 ηₛₚ=t/tₒ−1
b=100×ηₛₚ/C C=6.00 (g/L)
η=b/a
Mv=3207×η^{1.205}

### Production Example 1

### Process for Producing Polyarylene Resin A

Measured amounts of sodium hydroxide (14.01 g) and H₂O (1,120 mL) were introduced into a 1-L beaker. The contents were stirred with nitrogen bubbling thereinto to dissolve the sodium hydroxide. Thereto were added benzyltriethylammonium chloride (0.1744 g), bis (4-hydroxy-3,5-dimethylphenyl)methane [hereinafter often referred to as tetramethylbisphenol F or TmBPF] (23.79 g), and a mixture of bis (4-hydroxyphenyl)methane, (2-hydroxyphenyl)(4-hydroxyphenyl)methane, and bis(2-hydroxyphenyl)methane [BPF-D, manufactured by Honshu Chemical Industry Co., Ltd.; p,p′:o,p′:o,p′: o,o′=about 35:48:17] (7.96 g) . After the contents were stirred, the resultant aqueous alkali solution was transferred to a 2-L reactor. Thereafter, 2,6-dimethyl-4-tert-butylphenol (0.712 g) was added thereto.

Subsequently, terephthaloyl chloride (27.35 g) was dissolved in dichloromethane (560 mL), and this solution was transferred to a dropping funnel. The temperature of the periphery-of the polymerizer was kept at 20° C., and the dichloromethane solution was dropped thereinto from the dropping funnel over 30 minutes while stirring the aqueous alkali solution in the reactor. After the reaction mixture was continuously stirred for further 4 hours, acetic acid (4.62 mL) was added thereto and this mixture was stirred for30 minutes. Thereafter, the stirring was stopped and the organic layer was separated. This organic layer was washed once with 0.1 N aqueous sodium hydroxide solution (560 mL), subsequently washed twice with 0.1 N hydrochloric acid (420 mL), and then further washed twice with H₂O (420 mL)

The organic layer which had been washed was poured into methanol (3,000 mL). The precipitate obtained was taken out by filtration and dried to obtain polyarylate resin A, which had the following structure. The resin obtained had a viscosity-average molecular weight of 36,700.

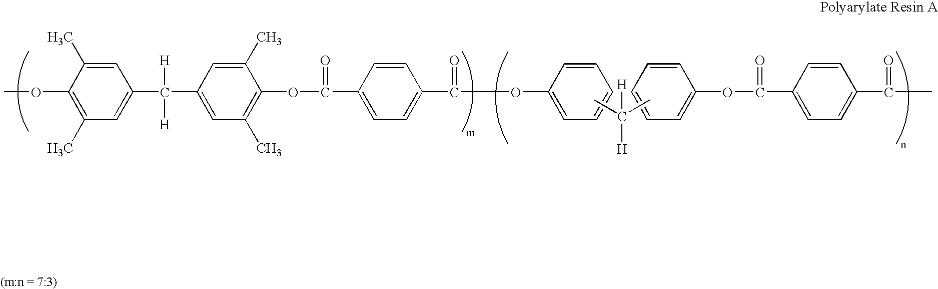

### Production Example 2

### Process for Producing Polyarylene Resin B

Measured amounts of sodium hydroxide (5.15 g) and H₂O (426 mL) were introduced into a 1-L beaker. The- contents were stirred with nitrogen bubbling thereinto to dissolve the sodium hydroxide. Thereto were added p-tert-butylphenol (0.2155 g), benzyltriethylammonium chloride (0.0632 g), and bis(4-hydroxy-3,5-dimethylphenyl)methane [tetramethylbisphenol F] (12.68 g) in this order. After the contents were stirred, the resultant aqueous alkali solution was transferred to a 2-L reactor.

Subsequently, isophthaloyl chloride (3.12 g) and terephthaloyl chloride (7.14 g) were dissolved in dichloromethane (200 mL), and this solution was transferred to a 200-mL dropping funnel.

The temperature of the periphery of the polymerizer was kept at 20° C., and the dichloromethane solution was dropped thereinto from the dropping funnel over 1 hour while stirring the aqueous alkali solution in the reactor. After the reaction mixture was continuously stirred for further 3 hours, acetic acid (1.7 mL), dichloromethane (100 mL), and H₂O (100 mL) were added thereto and this mixture was stirred for 30 minutes. Thereafter, the stirring was stopped and the organic layer was separated. This organic layer was washed twice with 0.1 N aqueous sodium hydroxide solution (400 mL), subsequently washed twice with 0.1 N hydrochloric acid (400 mL), and then further washed twice with H₂O (400 mL).

The organic layer which had been washed was poured into methanol (2,000 mL). The precipitate obtained was taken out by filtration and dried to obtain polyarylate resin B, which had the following structure. The binder resin obtained had a viscosity-average molecular weight of 32,700. 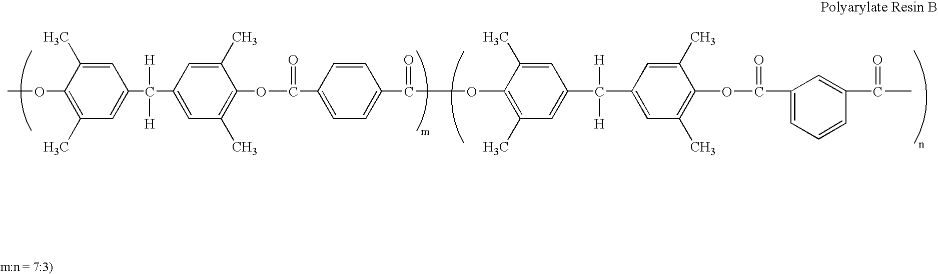
(Production of Photoreceptors)

### Example 1

Ten parts by weight of D-form oxytitanium phthalocyanine which, when examined with CuKₐ characteristic X-ray, gave an X-ray diffraction spectrum having a main diffraction peak at a Bragg angle (2θ±0.2) of 27.3° was mixed with 150 parts by weight of 4-methoxy-4-methylpentanone-2. This mixture was treated with a sand grinding mill for pulverization and dispersion to produce a pigment dispersion.

On the other hand, 100 parts by weight of a 5% 1,2-dimethoxyethane solution of poly(vinyl butyral) (trade name, Denka Butyral #6000C; manufactured by Denki Kagaku Kogyo K. K.) was mixed with 100 parts by weight of a 5% 1,2-dimethoxyethane solution of a phenoxy resin (trade name, PKHH; manufactured by Union Carbide Corp.) to produce a binder solution.

To 160 parts by weight of the pigment dispersion produced above were added 100 parts by weight of the binder solution and an appropriate amount of 1,2-dimethoxyethane to finally obtain a coating fluid for charge-generating layer formation which had a solid concentration of 4.0% by weight.

The coating fluid thus obtained was applied, in such an amount as to result in a film thickness of 0.3 μm, to a 75 μm-thick poly(ethylene terephthalate) film the surface of which had been coated with aluminum by vapor deposition. Thus, a charge-generating layer was formed.

Subsequently, a coating fluid for charge-transporting layer formation was prepared by mixing 40 parts by weight of charge-transporting compounds consisting of a mixture of the structural isomers represented by (i), (ii), and (iii) shown below, 100 parts by weight of polyarylene resin A produced in Production Example 1, 8 parts by weight of antioxidant IRGANOX 1076 (trade name), manufactured by Ciba-Geigy Ltd. and represented by the following structure formula (hereinafter often referred to as Irg 1076), as an antioxidant, 1 part by weight of the amine compound shown as Exemplified Compound (1) as another antioxidant, and0.03 parts by weight of a silicone oil as a leveling agent with 640 parts by weight of a tetrahydrofuran/toluene mixed solvent (mixing ratio, 80:20).

This coating fluid was applied on the charge-generating layer which had been formed on the film, and dried at 125° C. for 20 minutes to form a charge-transporting layer so as to have a thickness of 25 μm after drying. Thus, an electrophotographic photoreceptor was produced.

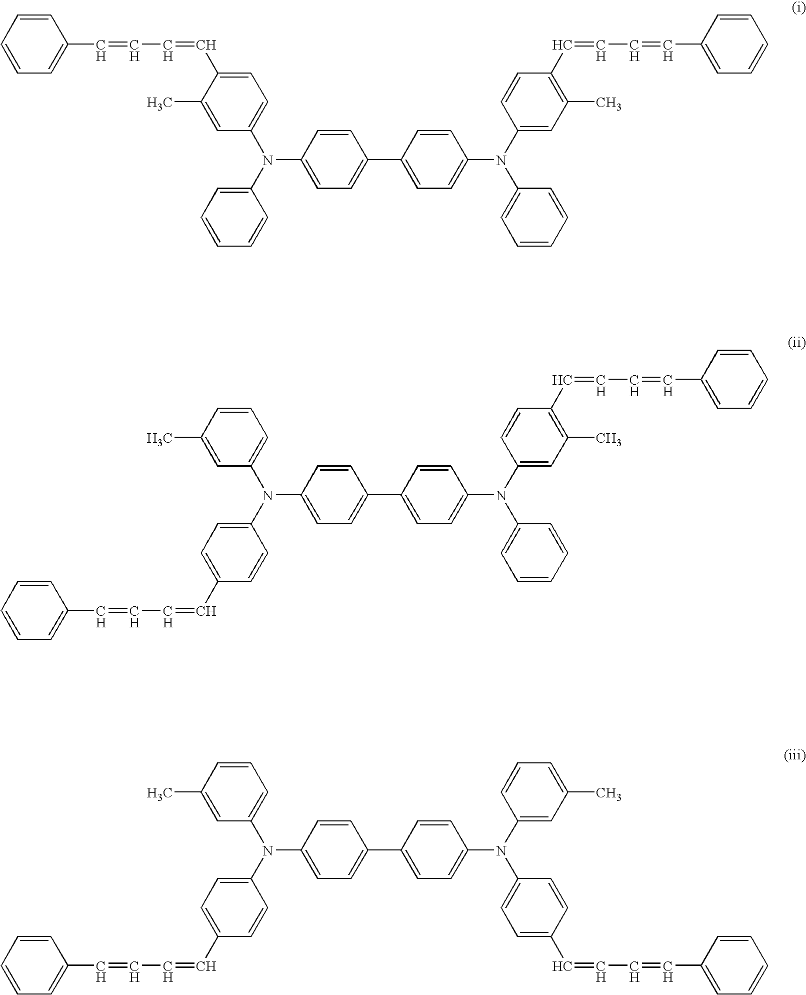

Charge-transporting compounds

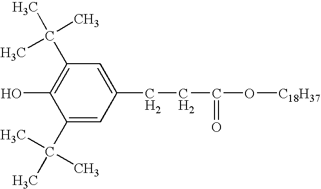

Antioxidant Irg 1076

### Example 2

An electrophotographic photoreceptor was produced in the same manner as in Example 1, except that 1 part by weight of the amine compound shown as Exemplified Compound (1) was incorporated as the only antioxidant into the coating fluid for charge-transporting layer formation of Example 1 without incorporating the 8 parts by weight of Irg 1076.

### Example 3

An electrophotographic photoreceptor was produced in the same manner as in Example 2, except that the amount of the amine compound, i.e., Exemplified Compound (1), used as an antioxidant was changed to 2 parts by weight.

### Example 4

A photoreceptor was produced in the same manner as in Example 2, except that polyarylate resin A produced in Production Example 1, which was used as a binder resin, was replaced with polyarylate resin B produced in Production Example 2.

### Example 5

An electrophotographic photoreceptor was produced in the same manner as in Example 4, except that the amount of the amine compound, i.e., Exemplified Compound (1), used as an antioxidant was changed to 2 parts by weight.

### Example 6

A photoreceptor was produced in the same manner as in Example 4, except that the amine compound, i.e., Exemplified Compound (1), used as an antioxidant was replaced with the amine compound shown as Exemplified Compound (3).

### Example 7

A photoreceptor was produced in the same manner as in Example 4, except that the amine compound, i.e., Exemplified Compound (1), used as an antioxidant was replaced with the amine compound shown as Exemplified Compound (6).

### Example 8

A photoreceptor was produced in the same manner as in Example 4, except that the amine compound, i.e., Exemplified Compound (1), used as an antioxidant was replaced with the amine compound shown as Exemplified Compound (7).

### Example 9

A photoreceptor was produced in the same manner as in Example 4, except that the amine compound, i.e., Exemplified Compound (1), used as an antioxidant was replaced with the amine compound shown as Exemplified Compound (13).

### Example 10

A photoreceptor was produced in the same manner as in Example 4, except that the amine compound, i.e., Exemplified Compound (1), used as an antioxidant was replaced with the amine compound shown as Exemplified Compound (17).

### Comparative Example 1

An electrophotographic photoreceptor was produced in the same manner as in Example 1, except that the antioxidants incorporated into the coating fluid for charge-transporting layer formation were not used.

### Comparative Example 2

An electrophotographic photoreceptor was produced in the same manner as in Comparative Example 1, except that 8 parts by weight of Irg 1076 was incorporated as an antioxidant into the coating fluid for charge-transporting layer formation.

### Comparative Example 3

An electrophotographic photoreceptor was produced in the same manner as in Comparative Example 1, except that polyarylate resin A produced in Production Example 1, which was used as a binder resin, was replaced with polycarbonate resin C having the following structure (viscosity-average molecular weight, 32,000).

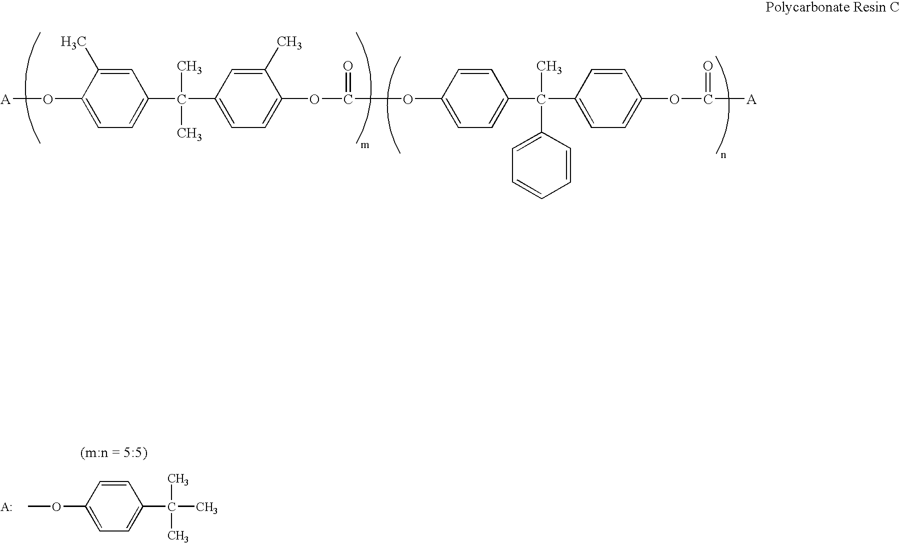

### Comparative Example 4

An electrophotographic photoreceptor was produced in the same manner as in Comparative Example 3, except that 8 parts by weight of Irg 1076 was incorporated as an antioxidant into the coating fluid for charge-transporting layer formation.

The electrophotographic photoreceptors obtained in Examples 1-10 and Comparative Examples 1-4 each were subjected to the following evaluations.

[Electrophotographic Properties]

An apparatus for evaluating electrophotographic properties (described in Zoku Denshishashin Gijutsu No Kiso To Ôyô, edited by The Imaging Society of Japan, Corona Publishing Co., Ltd., pp. 404-405) produced in accordance with the measurement standards of The Imaging Society of Japan was used. The photoreceptor was bonded to a drum made of aluminum so that the photoreceptor came to have a cylindrical shape and the drum made of aluminum and the aluminum base of the photoreceptor were electrically connected to each other. The drum was then rotated at a constant revolution speed to conduct a test for evaluating electrophotographic properties in cycles each comprising charging, exposure, potential measurement, and erase. In this test, the initial surface potential was set at −700 V, and 780-nm monochromatic light and 660-nm monochromatic light were used for exposure and erase, respectively. At the time when the photoreceptor had been irradiated with the 780-nm light in an amount of 2.4 μJ/cm², the surface potential (hereinafter often referred to as VL) was measured. In the VL measurement, the time required for the exposure and the potential measurement was set at 139 ms.

The measurement was made in an atmosphere having a temperature of 25° C. and a relative humidity of 50% or lower. The smaller the absolute value of this surface potential (VL), the better the electrophotographic properties. The results are shown in Table 1.

[Gas Resistance]

The charge acceptance of the photoreceptor sheet and the charge acceptance of the photoreceptor sheet which had been allowed to stand for 9 hours in an atmosphere having an ozone concentration of 150 ppm were examined with EPA-8100, manufactured by Kawaguchi Electric Works Co., Ltd. In the examination, measuring conditions including the current flowing into the charging device were kept constant, and the surface potential retention (%) was calculated by determining the ratio (percentage) of initial surface potential after exposure to ozone (V₀′)/initial surface potential before exposure to ozone (V₀). The more the surface potential retention is close to 100%, the better the gas resistance. The results are shown in Table 1.

[Degree of Improvement in Gas Resistance]

The degree in which the surface potential retention was improved by the incorporation of one or more antioxidants was evaluated as degree of improvement. The value obtained by subtracting the surface potential retention (%) of the photoreceptor containing no antioxidants from the surface potential retention (%) of the photoreceptor containing one or more antioxidants was taken as the degree of improvement. The results are shown in Table 1.

[Friction Test]

The coefficient of friction of the sheet-form photoreceptor produced above was measured with fully automatic friction/abrasion tester DFPM-SS, manufactured by Kyowa Interface Science Co., Ltd. A urethane rubber sheet having a thickness of 2 mm, width of 10 mm, and length of about 20 mm was bonded to the contacting element, and the tester was regulated so that this urethane rubber sheet was in contact with the photoreceptor at an angle of 45° over a width of 10 mm. A toner was evenly spread on the sheet-form photoreceptor in an amount of about 0.1 mg/cm². The contacting element was moved under the conditions of a load of 200 g, speed of 5 mm/sec, and stroke of20 mm to measure the coefficient of dynamic friction. The contacting element was moved 100 times, and the coefficient of dynamic friction as measured in the 100th movement is shown in Table 1.

[Abrasion Test]

The photoreceptor film was cut into a disk shape having a diameter of 10 cm and evaluated for abrasion with a Taber abrasion tester (manufactured by Toyo Seiki Ltd.). The test conditions were as follows. The test was conducted using abrading wheel CS-10F in an atmosphere having a temperature of 23° C. and a relative humidity of 50%. The abrading wheel was rotated under no load (with the own weight of the wheel) so as to make 1,000 revolutions. Thereafter, the abrasion wear was determined by comparing the weight before the test with that after the test. The results are shown in Table 1.

TABLE 1

| | | | | Surface | | | Taber |
|---|---|---|---|---|---|---|---|
| | | Antioxidant | | potential | Degree | Coefficient | abrasion |
| | Binder | (parts by | VL | retention | of improvement | of | wear |
| | resin | weight) | (−V) | (%) | (%) | friction | (mg) |
| Ex. 1 | Polyarylate | Irg 1076 (8) + | 66 | 91.1 | 24.4 | 0.49 | 3.4 |
| | resin A | Exemplified | | | | | |
| | | Compound 1 | | | | | |
| | | (1) | | | | | |
| Ex. 2 | Polyarylate | Exemplified | 41 | 94.2 | 27.5 | 0.50 | 3.3 |
| | resin A | Compound 1 | | | | | |
| | | (1) | | | | | |
| Ex. 3 | Polyarylate | Exemplified | 42 | 92.0 | 25.3 | 0.50 | 3.5 |
| | resin A | Compound 1 | | | | | |
| | | (2) | | | | | |
| Ex. 4 | Polyarylate | Exemplified | 45 | 93.2 | — | 0.49 | 3.6 |
| | resin B | Compound 1 | | | | | |
| | | (1) | | | | | |
| Ex. 5 | Polyarylate | Exemplified | 48 | 92.0 | — | 0.48 | 3.7 |
| | resin B | Compound 1 | | | | | |
| | | (2) | | | | | |
| Ex. 6 | Polyarylate | Exemplified | 48 | 93.5 | — | 0.50 | 3.8 |
| | resin B | Compound 3 | | | | | |
| | | (1) | | | | | |
| Ex. 7 | Polyarylate | Exemplified | 44 | 93.0 | — | 0.49 | 3.3 |
| | resin B | Compound 6 | | | | | |
| | | (1) | | | | | |
| Ex. 8 | Polyarylate | Exemplified | 38 | 91.8 | — | 0.48 | 3.4 |
| | resin B | Compound 7 | | | | | |
| | | (1) | | | | | |
| Ex. 9 | Polyarylate | Exemplified | 47 | 88.9 | — | 0.49 | 3.7 |
| | resin B | Compound 13 | | | | | |
| | | (1) | | | | | |
| Ex. 10 | Polyarylate | Exemplified | 49 | 90.5 | — | 0.48 | 3.6 |
| | resin B | Compound 17 | | | | | |
| | | (1) | | | | | |
| Comp. | Polyarylate | none | 31 | 66.7 | — | 0.51 | 3.2 |
| Ex. 1 | resin A | | | | | | |
| Comp. | Polyarylate | Irg 1076 (8) | 59 | 80.9 | 14.2 | 0.51 | 3.2 |
| Ex. 2 | resin A | | | | | | |
| Comp. | Polycarbonate | none | 27 | 84.7 | — | 0.66 | 6.2 |
| Ex. 3 | resin C | | | | | | |
| Comp. | Polycarbonate | Irg 1076 (8) | 26 | 94.2 | 9.5 | 0.66 | 6.2 |
| Ex. 4 | resin C | | | | | | |

The results given above show the following. The electrophotographic photoreceptors in which the photosensitive layer contains a polyarylate resin and a specific amine compound show such satisfactory mechanical properties that the coefficient of friction is low and the abrasion wear is small. Even after exposure to ozone, which is a typical gas causative of chemical deterioration, these electrophotographic photoreceptors have a satisfactory potential retention and a remarkably high degree of improvement and further have satisfactory electrophotographic properties.

### Example 11

Ten parts by weight of A-form (β-form) oxytitanium phthalocyanine was added to 150 parts by weight of 4-methoxy-4-methylpentanone-2. This mixture was treated with a sand grinding mill for pulverization and dispersion.

On the other hand, 100 parts by weight of a 5% 1,2-dimethoxyethane solution of poly(vinyl butyral) (trade name, Denka Butyral #6000C; manufactured by Denki Kagaku Kogyo K.K.) was mixed with 100 parts by weight of a 5% 1,2-dimethoxyethane solution of a phenoxy resin (trade name, PKHH; manufactured by Union Carbide Corp.) to produce a binder solution.

To 160 parts by weight of the pigment dispersion produced above were added 100 parts by weight of the binder solution and an appropriate amount of 1,2-dimethoxyethane to finally obtain a dispersion having a solid concentration of 4.0% by weight.

The dispersion thus obtained was applied by dip coating, in such an amount as to result in a film thickness after drying of 0.3 μm, to a tube made of aluminum which had a diameter of 3 cm and a length of 28.5 cm and the surface of which had undergone alumite treatment. Thus, a charge-generating layer was formed.

Subsequently, a liquid prepared by dissolving 40 parts by weight of the charge-transporting compounds, 100 parts by weight of polyarylate resin A produced in Production Example 1,8 parts by weight of 2,6-di-tert-butyl-4-methylphenol (BHT) as an antioxidant, 1 part by weight of Exemplified Compound (1) as another antioxidant, and 0.03 parts by weight of a silicone oil as a leveling agent in 640 parts by weight of a tetrahydrofuran/toluene mixed solvent (mixing ratio, 80:20) was applied to the aluminum tube by dip coating, and dried at 125° C. for 20 minutes to form a charge-transporting layer so as to have a thickness of 25 μm after drying. Thus, a tubular photoreceptor was obtained.

This photoreceptor was disposed in each of cartridges for full-color printer LP-3000C, manufactured by Epson Co., and these cartridges were mounted on the full-color printer. Images were continuously formed on 6,000 sheets so as to result in an image area proportion of 5% for each of the colors Y, M, C, and K. As a result, the photosensitive layer wore in an amount of about 3 μm, and no abnormality was observed in the images.

### Comparative Example 5

A photoreceptor was produced in the same manner as in Example 11, except that polycarbonate resin C was used in place of the polyarylate resin A as a binder resin for the charge-transporting layer. This photoreceptor was disposed in cartridges, which were mounted on the full-color printer. The photoreceptor was evaluated in the same manner s in Example 11. As a result, the photosensitive layer wore in an amount of about 6 μm, and the images had defects such as fogging and ghosts.

The results given above show that the image-forming apparatus employing cartridges equipped with the photoreceptor of the invention, which contains a polyarylate resin and a specific amine compound, stably gives satisfactory images even after repetitions of use.

Furthermore, according to the invention, an electrophotographic photoreceptor excellent in mechanical durability and in gas resistance and electrophotographic properties and satisfactory in stability and durability can be provided by using a polyarylate resin and the amine compound specified in the invention.

While the invention has been described in detail and with reference to specific embodiments thereof, it will be apparent to one skilled in the art that various changes and modifications can be made therein without departing from the spirit and scope thereof.

This application is based on a Japanese patent application filed on Dec. 6, 2002 (Application No. 2002-355605), the entire contents thereof being herein incorporated by reference.

### INDUSTRIAL APPLICABILITY

The electrophotographic photoreceptor of the invention is suitable for use in electrophotographic apparatus such as copiers, laser printers, and facsimile telegraphs.

1. An electrophotographic photoreceptor which comprises an electro conductive substrate and at least a photosensitive layer formed thereover, wherein the photosensitive layer contains an amine compound represented by the following formula (1) and a polyarylate resin. 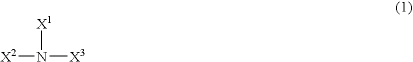
(In formula (1), X¹ and X² each independently represents an alkyl group which may have one or more substituents, and X³ represents an alkyl group which may have one or more substituents or an aryl group which may have one or more substituents.)

2. The electrophotographic photoreceptor according to claim 1, wherein the polyarylate resin contained in the photosensitive layer comprises one or more kinds of repeating structural units selected from the group consisting of unit represented by the following formula (2). 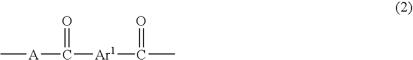
(In formula (2), A is a divalent organic group represented by the following formula (3), provided that when the polyarylate resin comprises two or more kinds of repeating structural units, then the A's may be the same or different. Ar¹ in formula (2) represents an arylene group, provided that when the polyarylate resin comprises two or more kinds of repeating structural units, then the Ar¹'s may be the same or different. 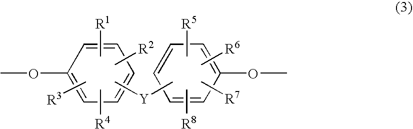
In formula (3), R¹ to R⁸ each independently represents a hydrogen atom or a substituent, and Y represents a single bond or a divalent group.)

3. The electrophotographic photoreceptor according to claim 2, wherein the polyarylate resin containing a repeating structure represented by formula (2) has a viscosity-average molecular weight of 15,000-100,000.

4. An image-forming apparatus which employs the electrophotographic photoreceptor according to claim 1 as an electrostatic latent-image forming element.

5. A cartridge for image-forming apparatus, the cartridge employing the electrophotographic photoreceptor according to claim 1 as an electrostatic latent-image forming element.

6. A method of image formation characterized by using the electrophotographic photoreceptor according to claim 1 as an electrostatic latent-image forming element.
